(19) United States
(12) Patent Application Publication
(10) Pub. No.: US 2004/0080816 A1
(43) Pub. Date: Apr. 29, 2004

(54) Operation microscope with an illuminating device

(76) Inventor: Jochen Koetke, Hamburg (DE)

Correspondence Address: ALIX YALE & RISTAS LLP, 750 MAIN STREET, SUITE 1400, HARTFORD, CT, 06103, US

(21) Appl. No.: 10/685,644

(22) Filed: Oct. 15, 2003

(30) Foreign Application Priority Data
Oct. 16, 2002 (EP) 02 023 052.0

(51) Int. Cl. G02B 21/00

(52) U.S. Cl. 359/368

(57) ABSTRACT

The operation microscope with an illuminating device, which is arranged behind the front lens (1) and illuminates the object plane (2) with a light patch (16), and in whose beam path (9) a diaphragm (6, 7) is arranged which partially covers said beam path, is characterized in that the light patch (16) can be moved with a translatory movement component in the object plane (2).

The invention relates to an operation microscope with an illuminating device which is arranged behind the front lens and illuminates the object plane with a light patch and in whose beam path a movable diaphragm is arranged which partially covers said beam path.

Such an arrangement projects the diaphragm, for example a slit diaphragm, precisely through the front lens into the object plane of the front lens and produces a light patch there which, in the case of a slit diaphragm, is a substantially rectangular, elongate light patch.

A so-called slit illumination or slit lamp is an indispensable aid to the ophthalmologist in the diagnosis of many eye diseases, because this illumination, in the form of a fine, sharply demarcated light patch, allows the internal and almost transparent structures of the examined eye to be viewed as it were in section and assessed. For this reason, slit illumination is used in operation microscopes for ophthalmic surgery, in this case also to create high-contrast illumination for the difficult optical control of the rhexis when performing surgery on particularly dense cataracts.

In surgical interventions in the posterior part of the eye, for example on the retina, slit illumination is used to view extremely fine membranes, the operation microscope in this case usually being extended with an optical attachment in order to compensate for the optical power of the eye being operated on, which is arranged in front of or below the front lens and generates in the microscope eyepiece an optically sharp image of structures inside the eye.

It is admittedly also known to provide the illuminating device below or in front of the front lens. However, when the illuminating device is arranged behind the front lens, the illumination through the front lens permits a compact construction of the microscope and only a small angle between the optical axes of the observation beam paths of the microscope and the illumination beam path, so that it is possible, when performing surgery on the retina, to illuminate areas of the retina which are observable through the microscope.

In a known operation microscope of the type mentioned at the outset, with slit illumination through the front lens, the slit diaphragm projected into the object plane can at most be rotated about the axis of the illumination beam path.

The object of the invention is to create an operation microscope with improved illumination of the operating site, which illumination has greater variability and with which better illumination can be achieved for operations.

The solution to the object lies in the fact that the light patch can be moved with a translatory movement component in the object plane.

In contrast to the prior art, the diaphragm is not just rotated about the optical axis of the illumination beam path, bringing about a corresponding rotation of the light patch. Rather, the light patch is moved relative to the center of the image field so that, in the case of a slit diaphragm, the operating site can be scanned with a “bar of light”, i.e. a light patch having the shape of an elongate rectangle. “Scanning” in this case also means that this scanning movement does not have to take place continuously, but instead can be stopped at a location which is particularly advantageous for the operation.

In an advantageous embodiment, the diaphragm is designed for a movement with a translatory component in the beam path perpendicular to the optical axis of the illuminating beam path. The bar of light or light patch will then also execute a largely translatory movement through the image field.

Alternatively, however, it is also possible for the illuminating device to be moved relative to the diaphragm, which produces a similar effect. Instead of or in addition to this, the light patch can, in another embodiment, be moved by pivoting of a deflection element for the illuminating light.

In an advantageous embodiment, the diaphragm, or to be more specific the diaphragm aperture, is arranged in a diaphragm support which can be moved perpendicular to the optical axis of the illuminating beam path. It can thus be moved exactly perpendicular to the optical axis. It is also possible for this movement to take place in two directions perpendicular to one another through use of suitable slide guides. In addition, provision can also be made for the diaphragm to be rotatable about an axis parallel to the optical axis of the illuminating beam path.

Instead of a movable diaphragm support, it is also possible to provide a diaphragm support which is rotatably mounted eccentrically with respect to the optical axis of the illuminating beam path. In this case too, the diaphragm aperture executes a translatory movement, which is superposed however by a rotation movement. How great the rotation movement is in relation to the translatory movement will depend on the extent to which the diaphragm support is eccentrically mounted.

More than one diaphragm aperture can be provided on the diaphragm support. For example, slit-shaped diaphragm apertures with different slit widths could be provided. One or more diaphragm apertures could also be circular, and these would illuminate the object plane or the eye eccentrically with respect to the image center in order to suppress stray light.

Instead of several diaphragm apertures of different sizes, provision can also be made for the size of the diaphragm aperture (the slit width or circle diameter) to be modified.

In another advantageous embodiment, the diaphragm aperture or diaphragm apertures is/are arranged on diaphragm supports which are partially transmitting at least in subareas. In this case, bright illumination is obtained in the area of the slit image or circle image and a greatly attenuated illumination is obtained around the latter, which can also be advantageous for many purposes.

The diaphragm(s) and/or the deflection element can be adjusted by hand, using suitable levers. In an advantageous embodiment, however, this adjustment is done by motor and can, for example, be triggered via a foot-actuated switch operated by the user.

The invention is described below on the basis of advantageous embodiments and with reference to the attached drawings, in which:

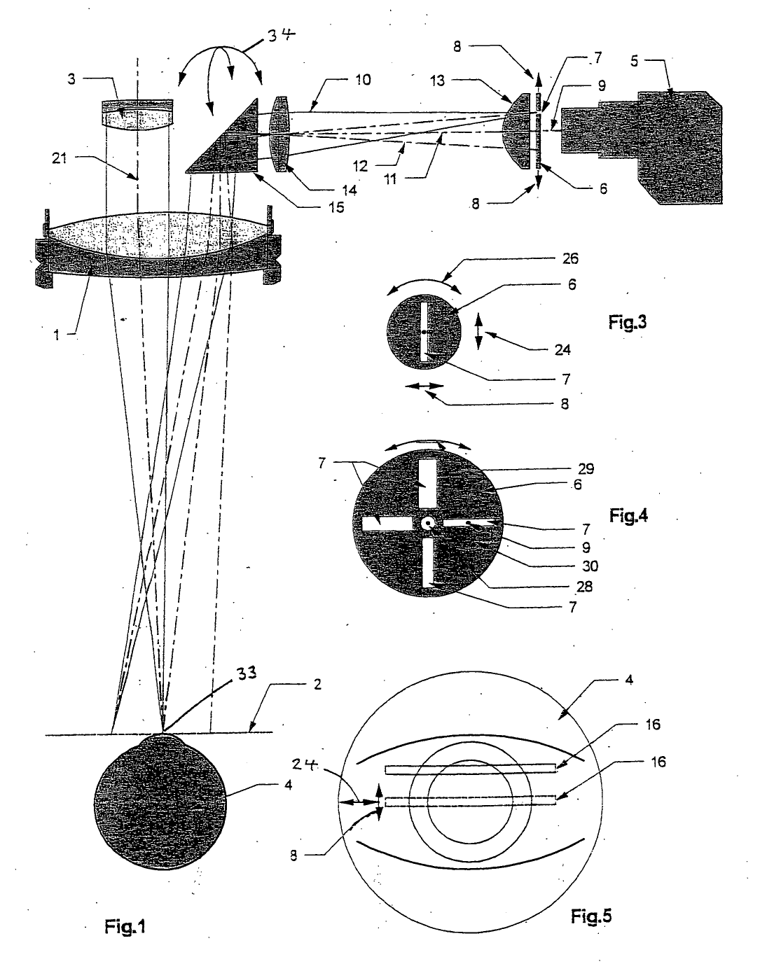

FIG. 1 shows, in a diagrammatic view and in lateral section, parts of the microscope and the illuminating device in a first embodiment,

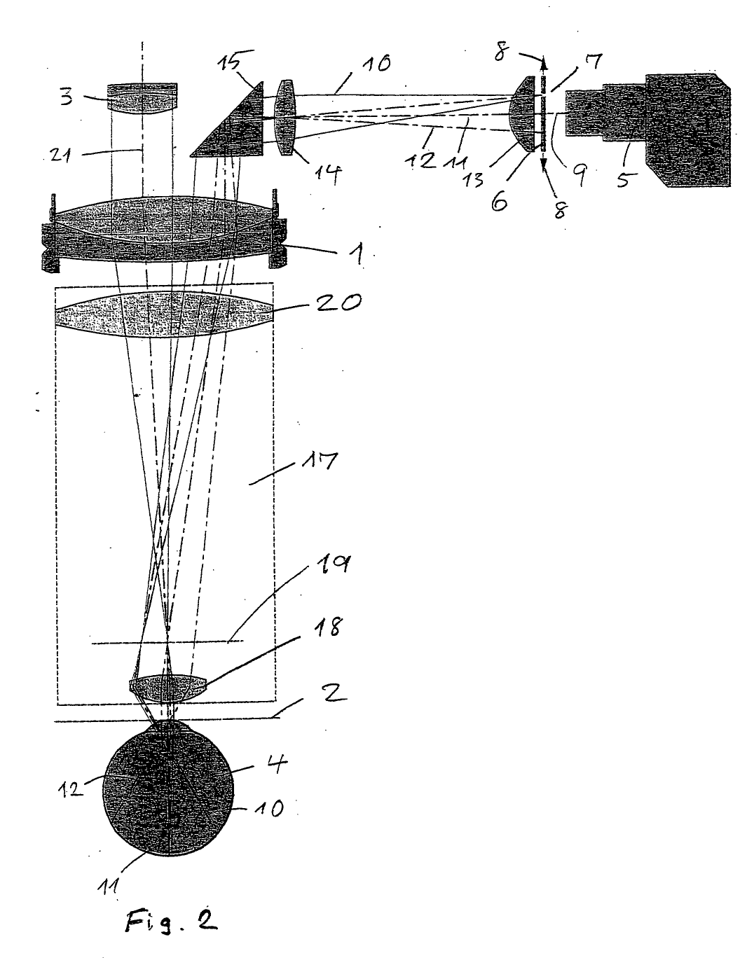

FIG. 2 shows, in a view similar to FIG. 1, another embodiment of the microscope with the illuminating device according to the invention;

FIG. 3 shows a first diaphragm support according to the invention, with its movement possibilities;

FIG. 4 shows a second diaphragm support according to the invention, with its movement possibilities;

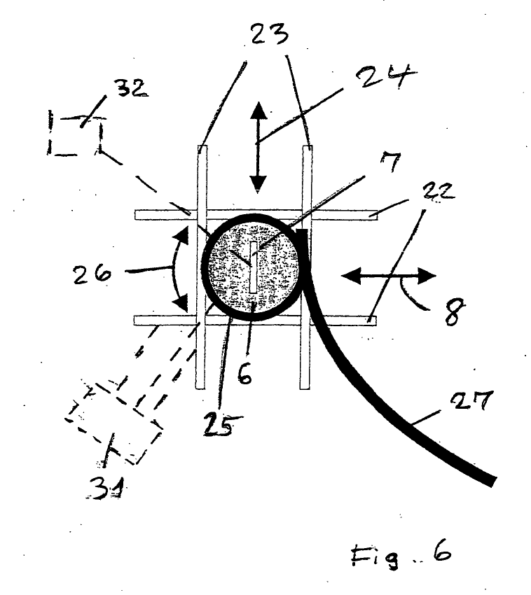

FIG. 5 shows a diagrammatic view of the eye, with the illuminating bar of light; and

FIG. 6 shows, in a diagrammatic view, an arrangement with which the movement possibilities in FIG. 3 can be achieved.

The microscope shown in FIGS. 1 and 2 has a front lens 1 through which it is possible to observe the image plane 2 with further optical elements, one of which elements is shown at 3. Such a microscope can be used to observe a human eye 4, for example. An illuminating device is also shown in FIGS. 1 and 2. The light source used here is, for example, the end 5 of an optical conductor. The light strikes a diaphragm support 6 which has a slit-shaped diaphragm aperture 7. The diaphragm support 6 with the diaphragm aperture 7 can be moved in the direction of the arrows 8, as is also indicated in FIG. 3, perpendicular to the axis 9 of the illuminating beam path and perpendicular to its longitudinal extent. In the position of the slit 7 shown in FIGS. 1 and 2, one obtains the beam path 10, shown by solid lines, which is projected further through optical elements 13, 14, 15, deflected, and projected through the front lens 1 onto the object plane 2. In other positions of the slit 7, beam paths are obtained of which only the central beam 11, 12 is shown in each case. As is shown in FIG. 5, this produces, on the eye 4, a line-shaped or bar-shaped light patch 16, of which two positions are shown and which can be moved in the direction of the double arrow 8 relative to the center 33 of the image field. The bar of light 16 is thus laterally movable on the cornea of the patient's eye 4 in order to set, in cataract operations for example, the position with optimum illumination contrast. Instead of the movement of the slit 7, or in addition to this, the deflection element 15 can be pivoted in the direction of the double arrows 34.

FIG. 2 shows basically the same construction of the illuminating device as in the embodiment in FIG. 1. This embodiment is advantageous for illuminating the posterior part of the eye 4. An optical attachment 17 is provided in front of or below the front lens to compensate for the optical power of the eye which is being operated on. Such attachment systems 17 often consist of a lens 18 of short focal length which projects the retina of the eye 4 or areas in front of the retina into an intermediate image plane 19. This intermediate image is observed by the microscope, if appropriate with additional optics 20 for adapting the optical observation beam path 21 of the microscope to the intermediate image and/or to ensure the image is the right way up and right way round. The illuminating light is projected sharply onto the appropriate part of the retina through the lens 18. By changing the position of the diaphragm aperture or by pivoting the deflection element 15, the bar of light or otherwise shaped light patch moves across practically the whole area of the retina and of the vitreous body viewable through the microscope and permits evaluation of the tissue.

As can be seen from FIG. 2, by moving the slit diaphragm 7 laterally, the user can move the bar of light 16 across the whole area of the retina viewable through the operation microscope, as is shown in FIG. 2 by the beams 10, 11, 12 inside the eye 4. A so-called endoillumination device, a thin optical conductor which is introduced into the posterior part of the eye and must be held by hand, is therefore not required.

It should also be noted that only one optical observation beam path 21 is shown in FIGS. 1 and 2. In the stereoscopic microscopes normally used in this field, two such beam paths 21 are of course present, but these would lie one behind the other in the view in FIGS. 1 and 2, and for this reason the second beam path is not shown.

As is shown in FIG. 6, in one embodiment, the diaphragm support 6 with the slit diaphragm 7 is arranged movably on two carriages which are arranged perpendicular to one another and indicated at 22 and 23. In this way, not only is a movement possible in the direction of the double arrow 8, but also a movement in the direction of the double arrow 24. In addition to the arrangement on this two-dimensional linear carriage 22, 23, rotation of the slit diaphragm 7 in the direction of the double arrow 26 is possible on a turntable indicated at 25. This turntable 25 is adjusted via a flexible shaft 27. The corresponding movement possibilities are also shown in FIG. 3.

FIG. 4 shows another embodiment of the diaphragm support 6. This is circular and is rotatable about an axis 28 in the direction of the double arrow 29. The axis 28 is offset in relation to the optical axis 9 of the illumination beam path, so that, upon rotation in the direction of the double arrow 29, a translatory movement also takes place which, however, is accompanied by a certain pivoting movement of the slit 7 and thus of the bar of light 16. This pivoting movement, however, is relatively small if the distance between the axes 9 and 22 is large enough.

In the embodiment in FIG. 4, it can be seen that slits 7 of different widths are arranged on the diaphragm support 6, so that the width of the bar of light 16 can also be chosen. A partially transmitting area of the diaphragm support 6 is also shown at 30. In this way, the eye 4 or the object plane 2 is illuminated not only with a sharply focussed bar of light 16, but a relatively large part of the eye 4 or of the object plane 2 with weaker diffuse light.

FIG. 6 shows, diagrammatically, motor-driven adjustment 31 in the direction of the double arrows 8, 24 and 26 and motor-driven adjustment 32 of the slit width. These adjustments can be effected, for example, by operating a foot-actuated switch which acts on electric motors in the elements 31, 32.

1. An operation microscope with an illuminating device (13, 14, 15) which is arranged behind the front lens (1) and illuminates the object plane (2, 19) with a light patch (16) and in whose beam path (9) a diaphragm (6, 7) is arranged which partially covers said beam path, wherein the light patch (16) can be moved with a translatory movement component in the object plane (2, 19).

2. The operation microscope as claimed in claim 1, wherein the diaphragm (6, 7) is designed for a movement with a translatory component (8) in the beam path perpendicular to the optical axis (9) of the illuminating beam path.

3. The operation microscope as claimed in claim 1 or 2, wherein the illuminating device (13, 14, 15) can be moved relative to the diaphragm.

4. The operation microscope as claimed in one of claims 1 through 3, wherein the light patch can be moved by pivoting (at 34) of a deflection element (15) for the illuminating light (10 through 12).

5. The operation microscope as claimed in one of claims 1 through 4, wherein the diaphragm (6, 7) is arranged in a diaphragm support (6) which can be moved perpendicular to the optical axis (9) of the illuminating beam path (4).

6. The operation microscope as claimed in one of claims 1 through 5, wherein the diaphragm (6, 7) can be moved in two directions (8, 24) perpendicular to one another and linearly perpendicular to the optical axis (9) of the illuminating beam path.

7. The operation microscope as claimed in claim 5 or 6, wherein the diaphragm (6, 7) can additionally be rotated about an axis (28) parallel to the optical axis (9) of the illuminating beam path.

8. The operation microscope as claimed in one of claims 1 through 4, wherein the diaphragm (6, 7) is arranged in a diaphragm support (6) which is rotatably mounted eccentrically (at 28) with respect to the optical axis (9) of the illuminating beam path.

9. The operation microscope as claimed in one of claims 5 through 8, wherein more than one diaphragm (6, 7) is provided on the diaphragm support (6).

10. The operation microscope as claimed in one of claims 1 through 9, wherein the diaphragm or at least one diaphragm (6, 7) is slit-shaped.

11. The operation microscope as claimed in one of claims 1 through 10, wherein the diaphragm or at least one diaphragm (6, 7) is circular.

12. The operation microscope as claimed in one of claims 1 through 11, wherein the size of the diaphragm (6, 7) (the slit width or circle diameter) can be modified.

13. The operation microscope as claimed in one of claims 1 through 12, wherein the diaphragm(s) is/are arranged on a diaphragm support which is partially transmitting at least in subareas (30).

14. The operation microscope as claimed in one of claims 1 through 10, wherein the diaphragm(s) (6, 7) and/or the deflection element (15) can be adjusted by motor.
